(19) United States
(12) Patent Application Publication
(10) Pub. No.: US 2003/0226274 A1
(43) Pub. Date: Dec. 11, 2003

(54) Structure of a tip hook of a tape rule

(75) Inventor: Henry Lin, Taipei (TW)

Correspondence Address: BRUCE H. TROXELL, SUITE 1404, 5205 LEESBURG PIKE, FALLS CHURCH, VA, 22041, US

(73) Assignee: INDEX MEASURING TAPE CO., LTD.

(21) Appl. No.: 10/164,608

(22) Filed: Jun. 10, 2002

(51) Int. Cl. G01B 3/10

(52) U.S. Cl. 33/758

(57) ABSTRACT

An improved structure of a tip hook of a tape rule, the tip hook has a braking section and a fixing section which is perpendicular to the braking section; the fixing section is provided for fixing the tip hook structure onto the tape, and the braking section is provided with a hook-adjusting mechanism; the hook-adjusting mechanism enables an opening formed onto the center of the braking section, and the both sides of the opening are provided with a front and a rear pressing boards, thus a slide groove is formed; the slide groove provides a slide sheet having a width corresponding to the opening for inlaying and sliding therein; therefore, the hooking area of the braking section can be extended opportunely, the hooking stability and the endurance can be enhanced, and a more secured and more convenient application to measurement is accomplished.

### BACKGROUND OF THE INVENTION

1. Field of the Invention

The present invention relates to a tip hook of a tape rule, and more particularly, to an improved structure of a tip hook having a hook-adjusting mechanism on the braking section thereof, thus the hooking area can be extended opportunely in order to enhance the hooking stability of the tape head and to accomplish a tape rule that is secured and more convenient for use.

2. Description of the Prior Art

The tape rule is a measuring tool with high mobility and convenience. As shown in FIG. 1, the conventional tape rule B generally comprises an elastic device (not shown) accommodated by a housing C, and a tip hook A combined the end of the tape B. The hook A is provided with a fixing section A1 fixed to the end of the tape B by a rivet; and a hook portion A2 is provided to the tip hook A. In order to prevent the tape B from being withdrawn into the housing C completely, it is trapped by the tip hook A outside the tape exit of the housing C; the tape B can be pulled out by plucking the tip hook A in order to proceed the measurement with propping the hook A up to the vertical surface of an object.

Although the conventional tape rule with such tip hook A has been widely used for many years, it still has considerable disadvantages as below:

Firstly, in order to form integrality and prevent from being too outstanding that would cause inconvenience for carrying, the area of the hook portion A2 of the tip hook was designed to be as small as possible initially. While measuring by the tape rule, the hook portion serves as a fixing end for hooking the object, and the tape can be extended by pulling the tape rule by the user after the hook portion is fixed, and then the dimensions can be measured. Nevertheless, as the area of the hook portion is too small, it would cause dangers of the slack hook to be withdrawn with great tension.

Secondly, although it is provided with certain strength since the tip hook is mostly made of metal, the hooking endurance between the hook and the object is relatively low because of the low friction coefficient of the metal surface. This is another reason why the hook is easily to be slacked off.

The present invention is generated finally after being analyzed and tested repeatedly by the inventor of the present invention who focused on the above-mentioned disadvantages of the conventional tip hook of the tape rule.

### SUMMARY OF THE INVENTION

Accordingly, it is an object of the present invention to provide a tape rule with an improved structure of a tip hook. According to the improved structure of a tip hook of a tape rule, a hook-adjusting mechanism for extending the hooking area opportunely is installed onto the braking section constructing the hooking portion of the tape rule, thus it is secured for use.

According to the improved structure of a tip hook of a tape rule, a gradine groove is formed onto the side of the braking section adhering to the surface of the object, and an elastic stop-sliding pad is installed into the groove. Thus, the hooking endurance between the hook and the object is improved, and the safety is enhanced. This is another object of the present invention.

### BRIEF DESCRIPTION OF THE DRAWINGS

FIG. 1 is a 3D perspective view showing a conventional tape rule.

FIG. 2 is a 3D perspective view showing the tape rule of the present invention.

FIG. 3 is a 3D perspective view showing the tip hook of the present invention.

FIG. 4 is a 3D perspective view showing the motion of the tip hook according to the present invention.

FIG. 5 shows the second example of the present invention.

FIG. 6 shows the motion of the tip hook according to the second example of the present invention.

FIG. 7 is a perspective view showing the situation before the present invention is operated.

FIG. 8 is a perspective view showing the situation after the present invention is operated.

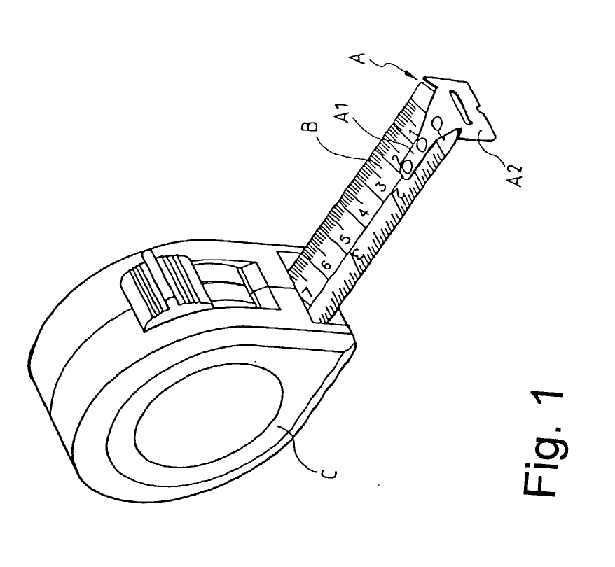

### DETAILED DESCRIPTION OF THE PREFERRED EMBODIMENT

The improved structure of the tip hook of the tape rule according to the present invention consists of: an elastic device inside the housing, the elasticity of the elastic device enables the tape to be withdrawn and accommodated into the housing; a tip hook is installed onto the front of the tape rule, the tip hook enables itself to be hooked onto the object, and also be detained against the tape exit for preventing the tape from being withdrawn into the housing completely and becoming invalid. The basic components thereof are described apparently by the fore cases and they are not repeated here.

Thereinafter, only the improvement of the present invention will now be explained in detail with reference to the accompanying drawings.

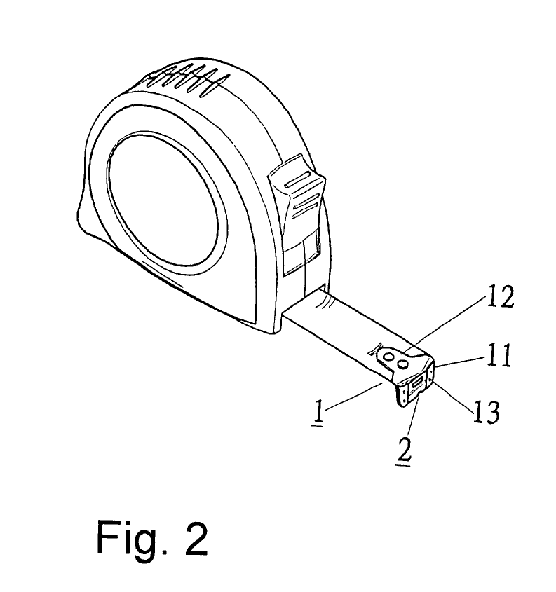

As shown in FIG. 2, the tape rule with an improved structure of a tip hook, wherein the tip hook 1 includes a braking section 11 and a fixing section 12; the fixing section 12 is combined with the tape by rivets or other fixing components; an opening 13 is formed onto the braking section 11, and a hook-adjusting mechanism 2 is set to the opening 13.

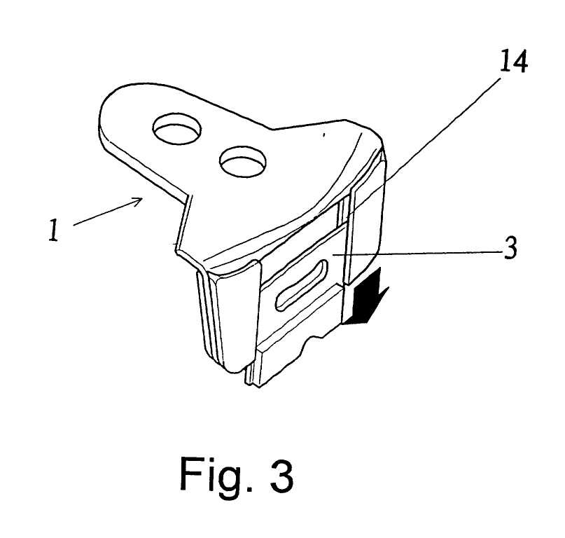

As shown in FIG. 3, wherein slide grooves 14 of the hook-adjusting mechanism 2 are formed onto both sides of the opening of the braking section 11.

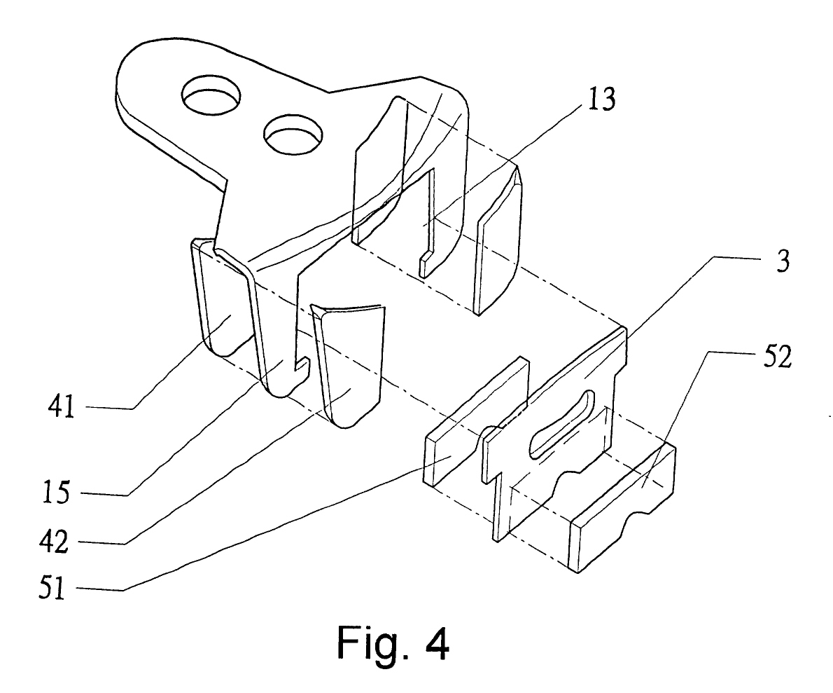

Please refer to FIG. 4 for the structure of the hook-adjusting mechanism 2. As shown in the figure, the opening 13 of the braking section 11 is a reversed convex opening, and the slide sheet 3 is reversed-convex shaped in accordance with the opening 13. On the braking section 11, pressing boards 41 and 42 are respectively fixed to the front and the rear of the slide pieces 15 of both sides of the opening. The area of the pressing board 41 or 42 is slightly larger than that of the slide piece 15. Thus the slide grooves 14, which are provided for sliding and extending the slide sheet, are formed. Pressing sheets 51 and 52 are respectively installed to the front and the rear of the bottom of the slide sheet 3; thus it is enabled to be integral with the braking section 11 when it is retracted into the opening 13, and to be convenient for being pulled out and controlled by the user.

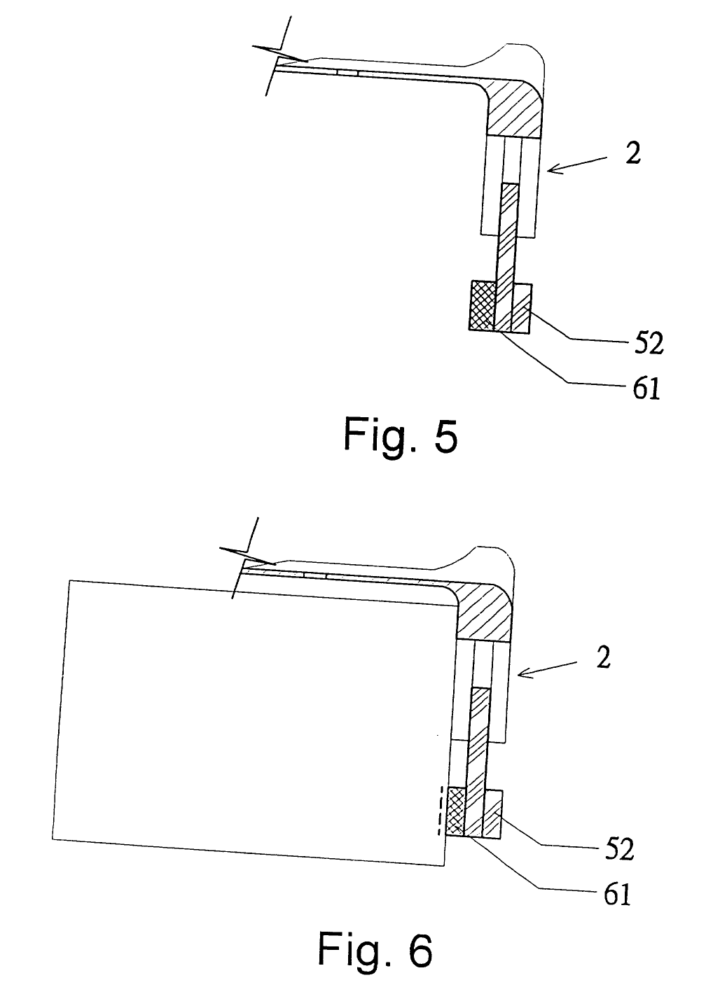

In addition, as shown in FIG. 5, the pressing sheets 51 and 52 at the rear of the hook-adjusting mechanism 2 can be elastic stop-sliding pads 61, of which the thickness can be slightly larger than that of the pressing boards 41 and 42 of the slide sheet. With this structure, when the stop-sliding pad is pressed onto the surface of the object, it can be adhered to the object since it is slightly contracted caused by the pressing force and the endurance to the object is enhanced thereby it is prevented from slacking off (as shown in FIG. 6). Alternatively, the rear pressing boards can also be stop-sliding pads.

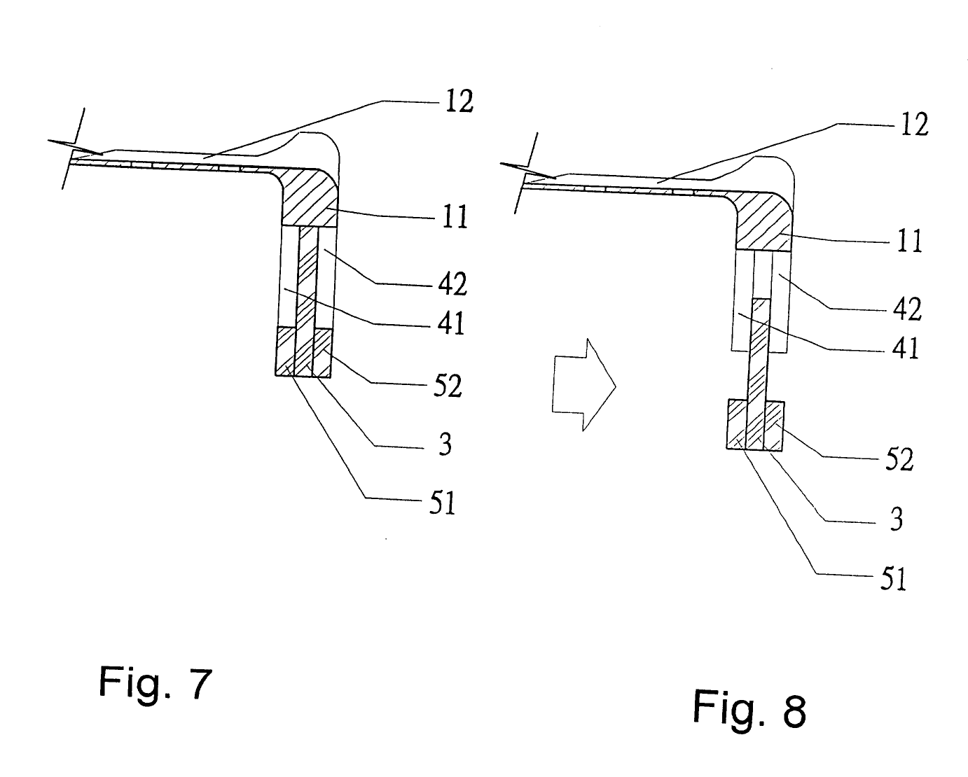

Accordingly, as shown in FIG. 7, since the braking section of the tip hook is provided with the hook-adjusting mechanism 2, the slide sheet 3 can be contracted into the opening while the tape rule is not in use, or it can be pulled out as in use (as shown in FIG. 8); therefore, it can increase the adhering area to the surface of the object and thereby enable a secured measurement.

It is known from the above description that the improved structure of a tip hook of a tape rule according to the present invention, by attaching a hook-adjusting mechanism to the braking section of the tip hook of a tape rule, the hooking area can be extended opportunely in order to accommodate the object that intended to be measured, thus the hooking endurance is enhanced and thereby it is prevented from slacking off; therefore, the safety for measurement is raised efficiently.

Although the present invention has been described using specified embodiment, the examples are meant to be illustrative and not restrictive. It is clear that many other variations would be possible without departing from the basic approach, demonstrated in the present invention.

What is claimed is:

1. An improved structure of a tip hook of a tape rule, which consists of a fixing section and a braking section; wherein, the fixing section is connected to the tape, and the braking section is provided for hooking an object; it is characterized in that: said braking section is provided with a slide mechanism and a slide sheet, such that the slide sheet can slide with the slide mechanism to extend the hooking area.

2. The improved structure of a tip hook of a tape rule as claimed in claim 1, wherein said slide mechanism on the braking section of the tip hook is formed to the both sides of the opening formed on the center of the braking section, wherein both sides of the opening of the braking section form a pair of slide grooves, and the both sides of the slide sheet form a pair of slide pieces, and thereby it enables the slide sheet to be retracted or pulled out.

3. The improved structure of a tip hook of a tape rule as claimed in claim 2, wherein said braking section is provided with a front and a rear pressing boards formed to the slide pieces on the both sides of the opening thereof, and the area of the pressing board is slightly larger than that of the slide piece; thus the slide grooves are formed.

4. The improved structure of a tip hook of a tape rule as claimed in claim 3, wherein the rear pressing board on said braking section can be a stop-sliding pad.

5. The improved structure of a tip hook of a tape rule as claimed in claim 1, wherein the pressing sheets can be installed to the front and the rear of said slide sheet.

6. The improved structure of a tip hook of a tape rule as claimed in claim S, wherein the pressing sheet of the slide sheet can be a stop-sliding pad.
